(19) United States
(12) Patent Application Publication
(10) Pub. No.: US 2015/0284031 A1
(43) Pub. Date: Oct. 8, 2015

(54) Heated Fender Well Liner

(71) Applicant: Richard C. Lee, Upper Marlboro, MD (US)

(72) Inventor: Richard C. Lee, Upper Marlboro, MD (US)

(21) Appl. No.: 14/244,506

(22) Filed: Apr. 3, 2014

(51) Int. Cl. B62D 25/18; H05B 1/02; B60R 16/033

(52) U.S. Cl. CPC B62D 25/18; B60R 16/033; H05B 1/0236

(57) ABSTRACT

A heated fender well liner assembly for use with a motor vehicle. The heated fender well liner assembly includes a fender well liner and a heater assembly. The fender well liner is attached to a motor vehicle. The heater assembly includes a resistive heating element which is embedded on or within the fender well liner and heats the surface thereof. The heated fender well liner assembly includes a sensor assembly, a timer, and a controller, and is connected through a switch to the motor vehicle battery.

### BACKGROUND OF THE INVENTION

1. Field of the Invention

The present invention relates to fender well liners for use with motor vehicles.

2. Description of the Related Art

Practically all motor vehicles have fender well liners attached thereto. Fender well liners are typically attached to motor vehicles in the fender wells. The fender well liner, is typically positioned somewhat inside the fender on top of the tires.

During use, fender well liners are exposed to the outside environment. Consequently, the fender well liner may be exposed to snow, rain and ice, all of which may accumulate thereon resulting in reduced traction because of excessive snow accumulation in the fender well.

What is needed in the art is a fender well liner which will resist the accumulation thereon of snow or ice, and remove any snow or ice which happens to accumulate thereon, thereby ensuring a cleaner ride with good traction.

### SUMMARY OF THE INVENTION

The present invention provides a heated fender well liner assembly for use with a motor vehicle.

The invention comprises, in one form thereof, a heated fender well liner assembly connected to a motor vehicle. The fender well liner assembly includes a fender well liner, and a heater assembly having a resistive heating element configured for heating the surface of the fender well liner. The fender well liner assembly includes a sensor assembly, a timer, and a controller, and is connected through the ignition switch of the motor vehicle to the motor vehicle battery.

An advantage of the present invention is that snow and ice does not accumulate on the surface of the fender well liner.

Another advantage is that the traction of the tires is improved as the heated water falls upon the snow clad threads of the vehicles tires.

Yet another advantage is that the precipitation or presence of snow or ice on the fender well liner can be detected and removed automatically, thus preventing accumulation thereof on the fender well liner.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a partially-sectioned view of a fender well liner assembly of the present Invention;

FIG. 2 is a block diagram of the fender well liner assembly of FIG. 1; and

FIG. 3 is a partially-sectioned view of a second embodiment of a fender well liner assembly of the present invention;

FIG. 4 is a partially-sectioned view of a second embodiment of a fender well liner assembly of the present invention.

Corresponding reference characters indicate corresponding parts throughout the several views. The exemplifications set out herein illustrate one preferred embodiment of the invention, in one form, and such exemplifications are not to be construed as limiting the scope of the invention in any manner.

### DETAILED DESCRIPTION OF THE INVENTION

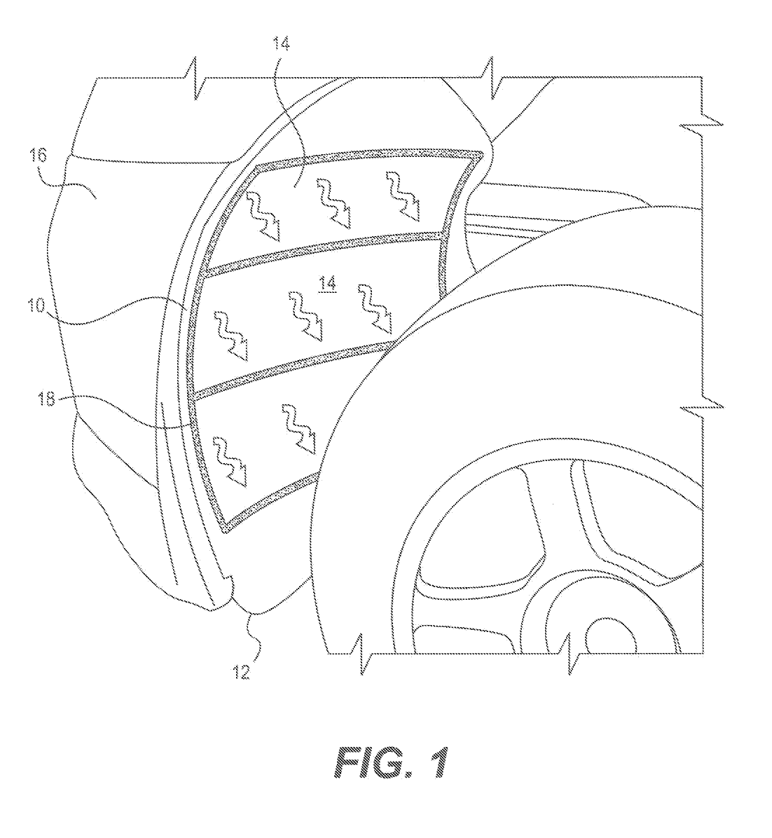

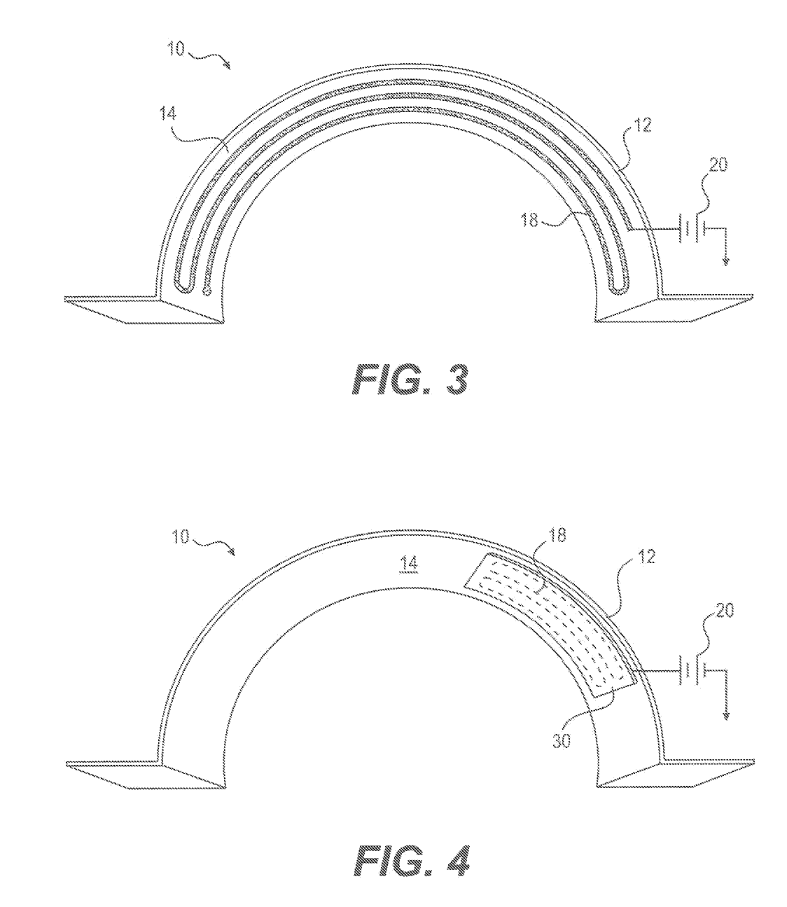

Referring now to the drawings and particularly to FIGS. 1 and 3, there is shown an embodiment of a heated fender well liner assembly 10 of the present invention. Heated fender well liner assembly 10 includes a fender well liner 12, and heating element 18. Fender well liner 12 is mechanically connected to motor vehicle 16 (shown in part).

Unless otherwise noted, details familiar to persons skilled in the electronic arts will be omitted since they are extraneous detail and thus have no bearing on reducing the invention to practice. Where in this application the terms “control”, “controlling” or the like are used, it is to be understood that such terms may include the meaning of the terms “regulate”, “regulating”, etc. That is such “control” may or may not include a feedback Loop. Moreover, it is also to be understood, and it will be appreciated by those skilled in the art, that the methodology and logic of the present invention described herein may be carried out using an number of structural configurations such as electronic hardware, software, and/or firmware, or the like.

Heating element 18 may be embedded on or within the fender well liner 12 and is electrically connected to and powered by motor vehicle battery 20. Heating element 18, which can be in the form of a resistive heating element or wire arranged in a serpentine pattern, heats the surface 14 of fender well liner 12. As used in this invention, heating surface 14 is the surface of the fender well liner facing the tires.

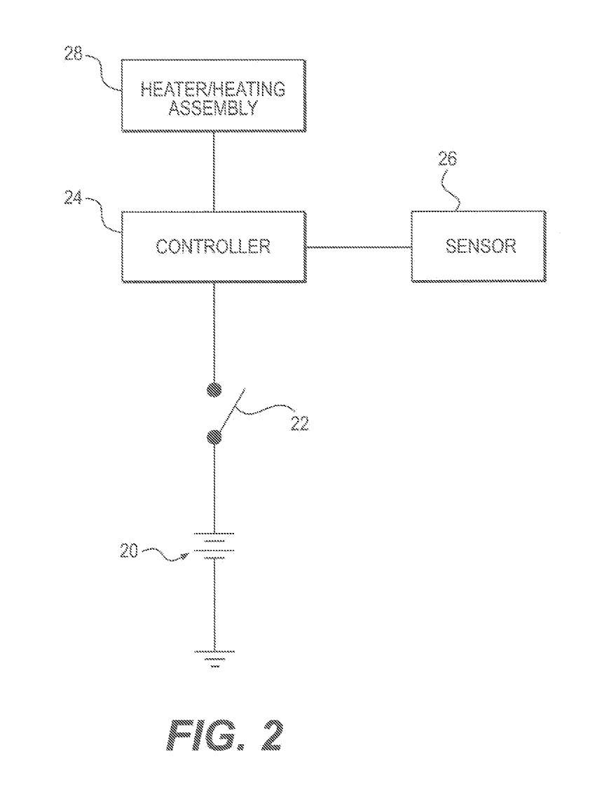

Referring to FIG. 2, motor vehicle battery 20 is electrically connected through motor vehicle ignition switch 22 to automatic controller 24. Sensor assemble 26 senses ambient temperature and/or moisture, and provides a signal indicative thereof to controller 24. Controller 24 controls the operation of heating assembly 28, which includes at least one heating element 18.

Sensor assembly 26 includes at least one sensor to sense ambient temperature and/or moisture. Sensor assembly 26 also includes any circuitry necessary to provide at least one signal indicative of the ambient temperature and/or moisture which is appropriate for inputting to controller 24. An example of a sensor which may combine moisture sensing and ambient temperature sensing is known is a snow sensor.

Controller 24 controls the operation of heating assembly 28 depending, in part, upon the signal of sensor assembly 26. More particularly, controller 24 monitors the signals from sensor assembly 26 and compares them against predetermined maximum or minimum levels, or thresholds. When the signal from sensor assembly 26 indicates to controller 24 that one or more of those predetermined maximum or minimum levels, or thresholds, has been exceeded, controller 24 activates heating assembly 28. However, before doing so, controller 24 also compares the voltage level of motor vehicle battery 20 to a predetermined level, thereby ensuring adequate power resides within motor vehicle battery 20 to drive heating assembly 28. Controller 24 also determines the state of motor vehicle ignition switch 22 (i.e., whether motor vehicle ignition switch 22 is on or off). If motor vehicle battery 20 has sufficient voltage, and if motor vehicle ignition switch 22 is activated, or “on”, controller 24 will activate heating assembly 28.

In another embodiment, controller 24 activates heating assembly 28 when motor vehicle ignition switch 22 is in the “off” position. Before doing so, controller 24 determines whether motor vehicle battery 20 has sufficient voltage to drive heating assembly 28. In this embodiment, controller 24 deactivates heating assembly 28 after a predetermined period of operation when motor vehicle ignition switch 22 is in the “off” position, thereby ensuring motor vehicle battery 20 is not depleted by an extended period of operation of heating assembly 28.

Referring to FIG. 4, a second embodiment of fender well liner assembly 10 includes fender well liner 12, heating element 18 and a protective layer 30. Heating element 18 is sandwiched within the protective layer 30, and is connected to motor vehicle battery 20. Protective layer 30 may be constructed of a material, for example rubber, that is electrically insulative but thermally conductive. In another embodiment, protective layer 30 is a thin sheet of metal designed to protect the heating assembly from the elements.

In use, automatic controller 24 automatically activates heating assembly 28 when the signals from sensor assembly 26 indicate an ambient temperature of 36° F. or less and/or the presence of moisture on or around fender well liner 12. Once heating assembly 28 is activated, electrical current flows through resistive heating element 18 which is embedded on or within fender well liner 12. Resistive heating element 18 emits heat as a result of the electrical current flow, and thereby heats surface 14. Any snow or ice that has previously accumulated on fender well liner 12 melts, while any snow or ice that is failing upon or impacting fender well liner 12 does not accumulate on surface 14, which is being heated by heating element 18.

Automatic controller 24, in the embodiment shown, is constructed as an integral unit which includes a number of separate subsystems or modules. However, it is to be understood that automatic controller 24 can be configured as a dedicated, stand-alone controller, or the function of automatic controller 24 can be incorporated into an existing microcomputer or controller on the motor vehicle to which fender well liner assembly 10 is attached.

In the embodiment shown, heating assembly 28 is configured with a single resistive heating element 18 which is embedded within fender well liner 12. However, it is to be understood that heating assembly 28 could be alternatively configured to achieve the same purpose. For example, heating assembly 28 could be configured to include several resistive heating elements to heat the surface or surfaces of one fender well liner, or could be configured to contain several resistive heating elements to heat the surfaces of several fender well liners.

Moreover, in the embodiment shown, heating element 18 is embedded within fender well liner 12. However, it is to be understood that heating element 18 could be alternatively configured to achieve the same purpose. For example, rather than being embedded within fender well liner 12, heating element 18 could be alternatively configured to be placed on or adhered to surface 14 of fender well liner 12.

Heating assembly 28 is, in the embodiment shown, configured with a resistive heating element 18. Heating assembly 28 can include, in addition to resistive heating element 18, ground fault interruption circuitry or protection and/or an independent fusing arrangement. Furthermore, it is to be understood that heating assembly 28 could be alternatively configured to achieve the same purpose. For example, heating assembly 28 could be configured to include a plurality of tubes which circulate a hot fluid, such as radiator fluid, or hot air, such as exhaust, through fender well liner 12, thereby heating surface 14.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A fender well liner assembly for use with a motor vehicle, the motor vehicle having a battery, said fender well liner assembly comprising:
a fender well liner having a heating surface facing the tires, said fender well liner configured for being attached to the motor vehicle; and
a heater assembly associated with said fender well liner, said heater assembly configured for heating at least a portion of said heating surface, said heater assembly configured for being powered by the battery of the motor vehicle.

2. The fender well liner assembly of claim 1, wherein said heater assembly includes at least one resistive heating element.

3. The fender well liner assembly of claim 2, wherein said at least one resistive heating element is embedded within said fender well liner.

4. The fender well liner assembly of claim 2, wherein said at least one resistive heating element is attached to said fender well liner.

5. The fender well liner assembly of claim 4, further comprising a layer of electrically insulating and thermally conductive material attached to said fender well liner, said layer of electrically insulating and thermally conductive material substantially covering said at least one resistive heating element.

6. The fender well liner assembly of claim 2, further comprising a layer of electrically insulating and thermally conductive material, wherein said layer of electrically insulating and thermally conductive material is attached to said fender well liner, said at least one resistive heating element being embedded within said layer of electrically insulating and thermally conductive material.

7. The fender well liner assembly of claim 1, wherein said heater assembly is configured for being powered by the battery of the motor vehicle.

8. The fender well liner assembly of claim 1, further including at least one switch having an “on” state and an “off” state, wherein said at least one switch selectively activates and deactivates said heater assembly.

9. The fender well liner assembly of claim 8, further comprising an automatic controller configured for at least one of automatically activating and deactivating said heater assembly.

10. The fender well liner assembly of claim 9, further comprising at least one sensor electrically connected to said automatic controller, said at least one sensor being configured for sensing at least one of ambient temperature and moisture, and for providing at least one sensor signal to thereby indicate said at least one of ambient temperature and moisture, said automatic controller receiving said at least one sensor signal and selectively controlling operation of said heater assembly dependent upon said at least one sensor signal.

11. The fender well liner assembly of claim 1, wherein said heater assembly is configured for at least one of melting accumulated snow from at least a portion of said heating surface of said fender well litter, preventing the accumulation of snow upon at least a portion of said heating surface of said fender well liner, and evaporating moisture from at least a portion of said heating surface of said fender well liner.

12. A method of removing accumulated snow and ice from a fender well liner of a motor vehicle, said method comprising the steps of:
providing a heating assembly, said heating assembly including at least one heating element;
associating said heating element with the fender well liner;
connecting said at least one heating element of said heating assembly to a power source, said power source being a battery of the motor vehicle; and
heating, the fender well liner by activating said at least one heating element.

13. The method of claim 12, wherein said associating step includes embedding said at least one heating element within the fender well liner.

14. The method of claim 12, wherein said associating step includes attaching said at least one heating element to said fender well liner.

15. A motor vehicle, comprising:
a body;
a battery carried by said body;
an ignition switch carried by said body; and
a fender well liner attached to said body, said fender well liner having a heating assembly including at least one heating element configured for heating at least a portion of said fender well liner and configured for being powered by said battery.

16. The motor vehicle of claim 15, wherein said at least one heating element comprises at least one resistive heating element electrically connected to said battery, said at least one resistive heating element being one of embedded within and attached to said fender well liner.

17. The motor vehicle of claim 15, wherein said at least one heating element is connected to said battery through said ignition switch such that actuating said ignition switch selectively activates and deactivates said at least one heating element.

18. The motor vehicle of claim 16, further comprising:
at least one sensor configured for sensing at least one of ambient temperature and moisture, and for providing at least one sensor signal to thereby indicate said at least one of ambient temperature and moisture; and
an automatic controller receiving said at least one sensor signal, and being configured to automatically activate and deactivate said heater assembly dependent upon said at least one sensor signal.

19. A motor vehicle comprising:
a fender well assembly;
a power source carried by said motor vehicle;
a heater assembly carried by and attached to said fender well assembly, said heater assembly including at least one resistive heating element; and
said power source connected to said at least one resistive heating element.

20. The motor vehicle of claim 19, wherein said fender well assembly comprises a fender well liner.

21. The motor vehicle of claim 19, wherein said heater assembly comprises a protective layer with said at least one resistive heating element sandwiched by the protective layer.

22. The motor vehicle of claim 19, wherein said power source is a battery of the motor vehicle.
